(19) United States
(12) Patent Application Publication
(10) Pub. No.: US 2006/0268365 A1
(43) Pub. Date: Nov. 30, 2006

(54) Imaging apparatus configured for scanning a document

(75) Inventor: Khageshwar Thakur, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/139,712

(22) Filed: May 27, 2005

(51) Int. Cl. H04N 1/04

(52) U.S. Cl. 358/474; 358/505

(57) ABSTRACT

An imaging apparatus configured for scanning a document includes a sensor for collecting image data. A phosphorescent material forming a phosphorescent area is located opposite the sensor, wherein the document is positioned between the sensor and the phosphorescent area during a scanning operation.

### BACKGROUND OF THE INVENTION

1. Field of the invention

The present invention relates to an imaging apparatus, and, more particularly, to an imaging apparatus configured for scanning a document.

2. Description of the related art

An imaging apparatus in the form of a scanner is used to generate a digital representation of a document being scanned. Such a document may include any of a variety of media types, such as paper, card stock, etc., and may be regular (e.g., rectangular) or irregular in shape, and on which there is formed, for example, text, graphics or a picture, e.g., a photo, or a combination thereof. Typically, a color scanner generates three channels of data, e.g., red, green and blue (RGB), in generating a scanned image of the document. Separation of a background associated with a backing surface of the scanner from a foreground, i.e., the scanned image, associated with the document has been a significant problem that those practicing in the imaging art continue to address.

Distinguishing between background and foreground is particularly problematic when the background and the foreground both have the same color, such as white. For example, this problem routinely arises when the image of a white document is placed in front of a white background. More specifically, when a target document, such as business card, having a white perimetrical region is scanned against a white document pad, it may be difficult to distinguish the boundaries of the business card from the background formed by the white document pad. Knowing the boundaries of the scanned document is useful because that increases the accuracy of skew correction. Knowing the boundaries of the scanned document also enables the accurate placement of the contents of the document with respect to a printed output.

Most current scanners come with some type of skew correction and content placement software. However, such scanners use the content of the scanned image as a guide, and sometimes such content-based guidance can be misleading. For example, in a cropped image, when some of the elements are lost with respect to the background, the skew correction becomes faulty. Using a colored document pad, e.g., other than white, does not solve the problem, but only shifts the problem in the color spectrum, since this solution will fail when the scanned image includes a perimetrical color that is the same as the color of the background.

### SUMMARY OF THE INVENTION

The invention, in one exemplary embodiment, is directed to an imaging apparatus configured for scanning a document. The imaging apparatus includes a sensor for collecting image data. A phosphorescent material forming a phosphorescent area is located opposite the sensor, wherein the document is positioned between the sensor and the phosphorescent area during a scanning operation.

The invention, in another exemplary embodiment, is directed to an imaging apparatus. The imaging apparatus includes a controller and a scanner unit coupled to the controller for scanning a document. The scanner unit includes an illuminant, and a document glass having a first side for supporting the document to be scanned and a second side opposite the first side. A sensor is positioned to face the second side of the document glass. A phosphorescent material forms a phosphorescent area positioned to face the first side of the document glass.

One advantage of the present invention is the ability to find a border of the document being scanned by sensing light emission from the phosphorescent material, and this may be achieved without using image data, e.g., RGB data, representing the contents of the scanned document, so as to separate the foreground, i.e., document, from the background.

Another advantage is that since it is very unlikely to scan a phosphorescent paper during a scanning operation, a phosphorescent document pad is unlikely to fail with respect to a document border determination.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagrammatic depiction of an imaging system embodying the present invention.

FIG. 2 is a diagrammatic representation of an embodiment of the scanner unit used in the imaging system of FIG. 1.

FIG. 3 illustrates light originating from the illuminant of the scanner head, and light emitted by the phosphorescent material of the phosphorescent area of the document pad, of FIG. 2.

FIG. 4A shows an exemplary document positioned against the background provided by the phosphorescent area of the document pad of FIG. 2.

FIG. 4B shows an exemplary representation of a dark image of the document of FIG. 4A generated using the light emitted by the phosphorescent material from the phosphorescent area of the document pad of FIG. 2.

FIG. 4C illustrates the border of the document of FIG. 4A determined in accordance with the present invention.

FIG. 5 is a diagrammatic representation of another embodiment of the present invention, wherein a dedicated illuminant is used to charge the phosphorescent material.

FIG. 6 is a diagrammatic representation of another embodiment of the present invention, wherein a fixed position illuminant used to charge the phosphorescent material is located below the document glass of the scanner unit.

FIG. 7 is a diagrammatic representation of another embodiment of the present invention, wherein a backlighting illuminant is used to charge the phosphorescent material.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

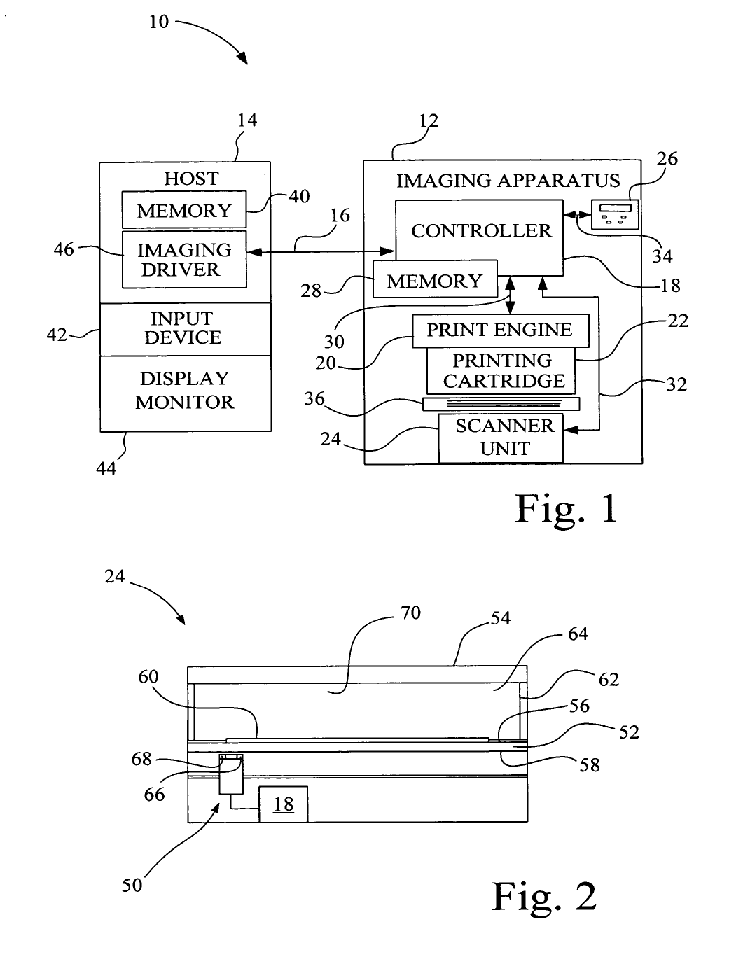

Referring now to the drawings and particularly to FIG. 1, there is shown a diagrammatic depiction of an imaging system 10 embodying the present invention. As shown, imaging system 10 may include an imaging apparatus 12 and a host 14. Imaging apparatus 12 communicates with host 14 via a communications link 16. As used herein, the term “communications link” is used to generally refer to structure that facilitates electronic communication between multiple components, and may operate using wired or wireless technology.

Imaging apparatus 12 may be, for example, an ink jet printer and/or copier; an electrophotographic printer and/or copier; a thermal transfer printer and/or copier; an all-in-one (AIO) unit that includes a print engine, a scanner unit, and possibly a fax unit; or may be simply just a scanner unit. An AIO unit is also known in the art as a multifunction machine. In the embodiment shown in FIG. 1, however, imaging apparatus 12 is shown as a multifunction machine that includes a controller 18, a print engine 20, a printing cartridge 22, a scanner unit 24, and a user interface 26. Imaging apparatus 12 may communicate with host 14 via a standard communication protocol, such as for example, universal serial bus (USB), Ethernet or IEEE 812.1x.

Controller 18 includes a processor unit and associated memory 28, and may be formed as one or more Application Specific Integrated Circuits (ASIC). Memory 28 may be, for example, random access memory (RAM), read only memory (ROM), and/or non-volatile RAM (NVRAM). Alternatively, memory 28 may be in the form of a separate electronic memory (e.g., RAM, ROM, and/or NVRAM), a hard drive, a CD or DVD drive, or any memory device convenient for use with controller 18. Controller 18 may be a printer controller, a scanner controller, or may be a combined printer and scanner controller. In the present embodiment, controller 18 communicates with print engine 20 via a communications link 30. Controller 18 communicates with scanner unit 24 via a communications link 32. User interface 26 is communicatively coupled to controller 18 via a communications link 34. Controller 18 serves to process print data and to operate print engine 20 during printing, as well as to operate scanner unit 24 and process data obtained via scanner unit 24.

In the context of the examples for imaging apparatus 12 given above, print engine 20 can be, for example, an ink jet print engine, an electrophotographic print engine or a thermal transfer engine, configured for forming an image on a print medium 36, such as a sheet of paper, transparency or fabric. As an ink jet print engine, for example, print engine 20 operates printing cartridge 22 to eject ink droplets onto print medium 36 in order to reproduce text and/or images. As an electrophotographic print engine, for example, print engine 20 causes printing cartridge 22 to deposit toner onto print medium 36, which is then fused to print medium 36 by a fuser (not shown), in order to reproduce text and/or images. 5 Host 14, which may be optional, may be, for example, a personal computer, including memory 40, such as RAM, ROM, and/or NVRAM, an input device 42, such as a keyboard, and a display monitor 44. Host 14 further includes a processor, input/output (I/O) interfaces, and at least one mass data storage device, such as a hard drive, a CD-ROM and/or a DVD unit.

Host 14 includes in its memory a software program including program instructions that function as an imaging driver 46, e.g., printer/scanner driver software, for imaging apparatus 12. Imaging driver 46 is in communication with controller 18 of imaging apparatus 12 via communications link 16. Imaging driver 46 facilitates communication between imaging apparatus 12 and host 14, and may provide formatted print data to imaging apparatus 12, and more particularly, to print engine 20, to print an image.

In some circumstances, it may be desirable to operate imaging apparatus 12 in a standalone mode. In the standalone mode, imaging apparatus 12 is capable of functioning without host 14. Accordingly, all or a portion of imaging driver 46, or a similar driver, may be located in controller 18 of imaging apparatus 12 so as to accommodate printing during a copying or facsimile job being handled by imaging apparatus 12 when operating in the standalone mode.

Scanner unit 24 may be of a conventional scanner type, such as for example, a sheet feed or flat bed scanner. In the context of the present invention, in some embodiments either scanner type may be used. As is known in the art, a sheet feed scanner transports a document to be scanned past a stationary sensor device.

Referring to FIG. 2, there is shown an embodiment of the present invention where scanner unit 24 is a flat bed scanner. Scanner unit 24 includes a scanner head 50 (e.g., a scan bar), a document glass 52 and a scanner lid 54. Document glass 52 has a first side 56 that faces scanner lid 54, and a second side 58 that faces away from scanner lid 54. First side 56 of document glass 52 provides support for a document 60 during a scanning operation.

FIG. 2 shows scanner unit 24 with scanner lid 54 in an open position. Scanner lid 54 may be moved from the open position, as shown in FIG. 2, to a closed position that covers document glass 52. Affixed to scanner lid 54 is a document pad 62. Document pad 62 has a surface 64 that forms a background for document 60 being scanned. Scanner head 50 includes an illuminant 66, e.g., one or more lamps, LED arrays, etc., and a sensor 68, e.g., one or more reflectance sensor arrangements, that are scanned across the document 60 to collect image data relating to document 60. Each of illuminant 66 and sensor 68 is positioned to face second side 58, e.g., the under side, of document glass 52. Each of illuminant 66 and sensor 68 is communicatively coupled to controller 18.

In accordance with the present invention, surface 64 of document pad 62 is made of a phosphorescent material that forms a phosphorescent area 70 located opposite sensor 68. The phosphorescent material may be obtained, for example, from United Minerals and Chemical Corporation (UMC) of Lyndhurst, New Jersey. The phosphorescent material is charged, i.e., absorbs light, when exposed to a light source, and discharges, i.e., emits, light after being charged. In one embodiment, for example, phosphorescent area 70 is formed by a phosphorescent coating, such as a phosphorescent paint, applied to a substrate, such as a plastic plate forming a portion of document pad 62. Also, it is contemplated that the phosphorescent material may be sprinkled, in a dry or liquid form, on to a holding layer, which may include an adhesive binder. In these examples, therefore, the phosphorescent material may be applied uniformly or non-uniformly in phosphorescent area 70. In addition, the phosphorescent material may be applied in phosphorescent area 70 in a predetermined pattern, such as for example, a grid pattern.

The light source that charges the phosphorescent material may be, for example, illuminant 66, or some other controlled illuminant, providing dedicated or leaked light, or may be ambient light. In order to charge the phosphorescent material using ambient light, scanner lid 54 is place in the open position so that ambient light may reach phosphorescent area 70. Illuminant 66 may be, for example, the same illuminant used to collect RGB data from document 60 via scanner head 50.

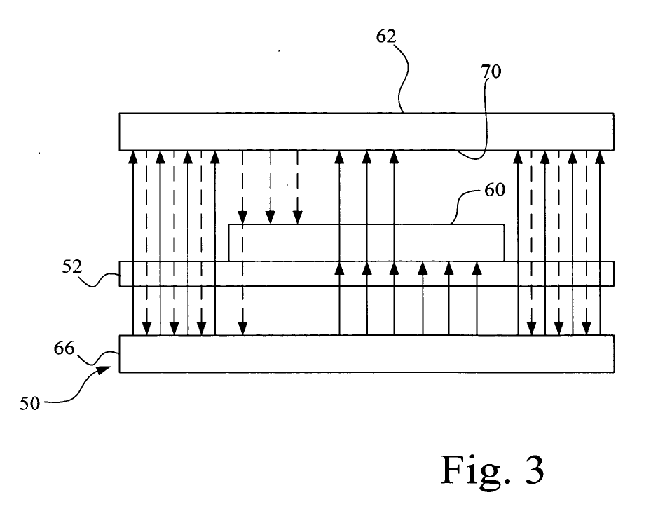

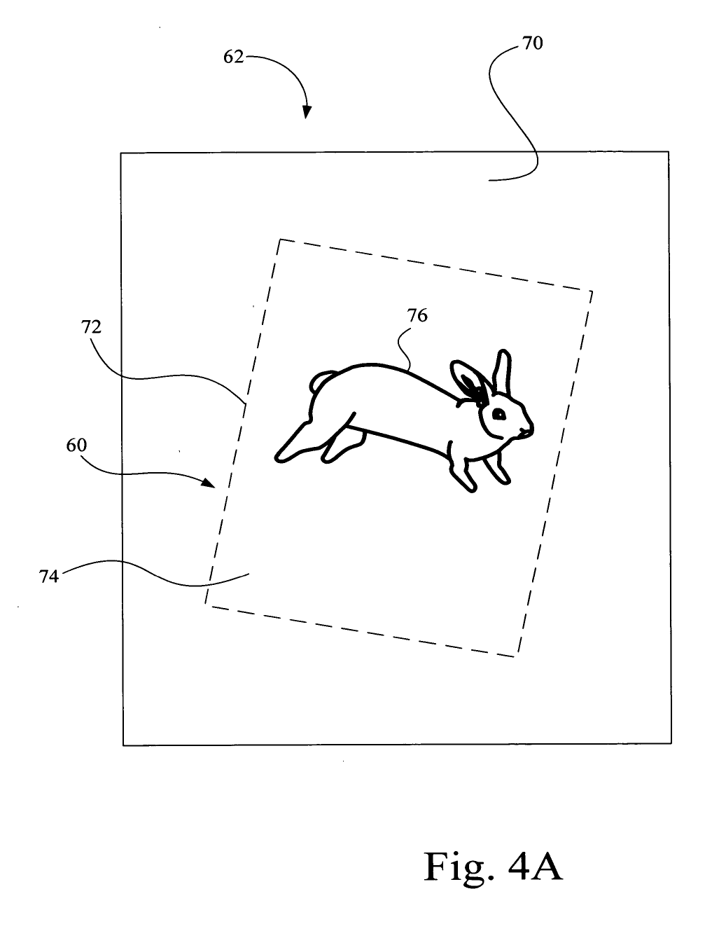

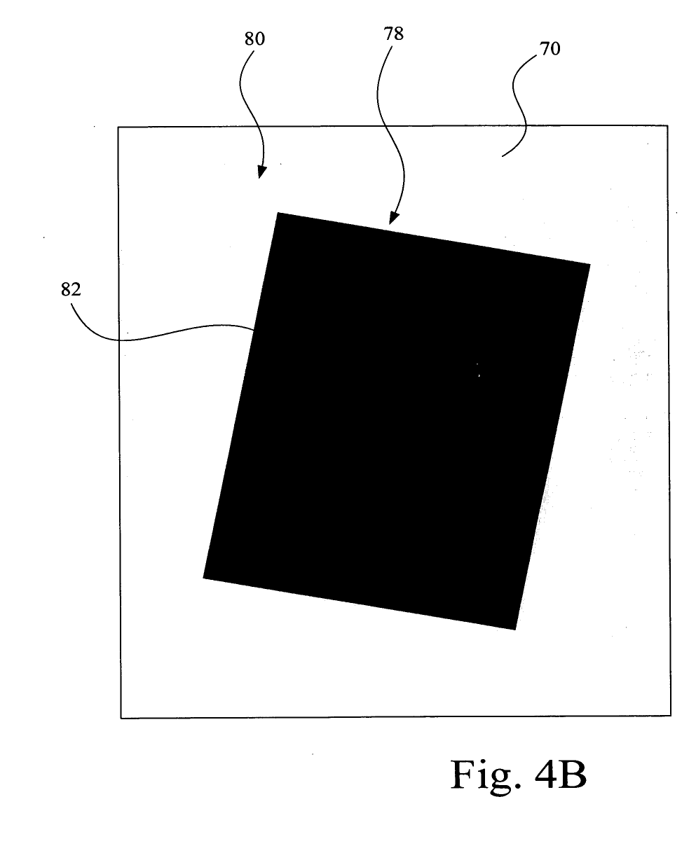

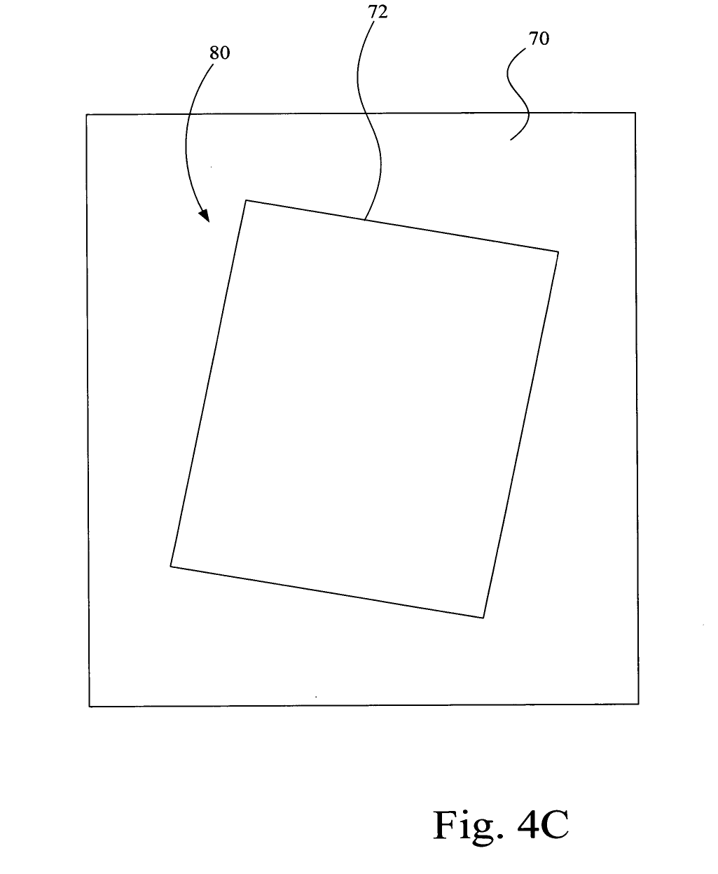

In the embodiment shown in FIG. 2, the phosphorescent material forming phosphorescent area 70 is positioned to face first side 56 of document glass 52. In the illustration of FIG. 3, light originating from illuminant 66 of scanner head 50 is represented by solid arrowed lines, and light emitted by the phosphorescent material of phosphorescent area 70 of document pad 62 is represented by dashed arrowed lines. FIG. 4A shows document 60 positioned against the background provided by phosphorescent area 70. Document 60 has a border 72, which in this example constitutes the four edges of a rectangular medium 74 on which a picture 76 is formed.

As shown in FIG. 3, when document 60 is positioned between document pad 62 and scanner head 50, light is attenuated during the charge of the phosphorescent material (represented by the shorter solid arrowed lines) and is attenuated during the discharge of the phosphorescent material (represented by the shorter dashed arrowed lines) in the area associated with document 60. Accordingly, and referring to FIG. 4B, during light emission of the phosphorescent material of phosphorescent area 70 in the substantial absence of light from other sources, a dark image 78 of document 60 is formed that may be sensed by sensor 68. Dark image 78 has a high contrast ratio with respect to the background 80 defined by the portion of phosphorescent area 70 that is not attenuated by document 60.

Referring to FIGS. 2 and 3, during one exemplary scanning operation, for example, document 60 is positioned between sensor 68 and phosphorescent area 70. As shown in the embodiment of FIGS. 4A and 4B, phosphorescent area 70 is greater than a surface area of document 60. Controller 18 executes program instructions to control illuminant 66 and to read sensor 68 to collect RGB (three channel) image data associated with document 60, and to collect dark image (fourth channel) data associated with dark image 78 of document 60. However, controller 18 may use only the dark image data relating to a boundary 82 of dark image 78, and not the RGB image data, to determine the border 72 of document 60.

For example, in order to generate the dark image data, sensor 68 provides signals to controller 18 relating to light emitted by the phosphorescent material at various locations on phosphorescent area 70, wherein document 60 is sensed by sensor 68 as dark image 78 in comparison to the background 80 formed by the portion of phosphorescent area 70 not attenuated by document 60 (see FIGS. 2, 3 and 4B).

In some embodiments of the present invention, the dark image data (D) may be generated to be interleaved with regular RGB image data, and this may be achieved in several different ways.

For example, one way is for controller 18 to take one or more dark image readings with sensor 68 after every RGB image reading taken with sensor 68. This may be represented by the sequence: RGB.DDD.RGB.DDD . . . , where D represents a dark image reading and RGB represent the red, green, blue image readings, respectively.

In the event it is determined that taking triple dark image readings after each RGB reading is not necessary in order to build a suitable boundary edge map of boundary 82 of dark image 78, representing the border 72 of document 60, then controller 18 may take multiple RGB readings with sensor 68 before taking each of the triple dark image readings with sensor 68, so that the overall number of dark image readings may be reduced. For example, this sequence may be: RGB.RGB.RGB.DDD.RGB.RGB . . . . As a further reduction, each of the triple dark image readings may be reduced to a double or single dark image reading, exhibited by the sequence: RGB.RGB.RGB.D.RGB.RGB . . . . By reducing the number of dark image readings D, the RGB image resolution is increased.

In embodiments where illuminant 66 is used in collecting RGB image data relating to the content of document 60 and for charging the phosphorescent material at phosphorescent area 70, the phosphorescent material is charged when illuminant 66 is ON, and controller 18 executes program instructions to turn OFF illuminant 66 while light emitted by the phosphorescent material is being sensed by sensor 68.

As another example, where ambient light is used to charge the phosphorescent material, the ambient light is substantially blocked, such as by closing scanner lid 54, while the light emitted by the phosphorescent material is being sensed by sensor 68.

The dark image data and the RGB image data are processed by controller 18, or in other embodiments by other firmware or software residing in imaging apparatus 12 and/or host 14, which in turn separates the dark image 78 and the background 80 based on the high contrast between the two to determine the boundary 82 of dark image 78. In turn, referring to FIG. 4C, the border 72, i.e., edge coordinates, of document 60 is then extracted from the background 80, thereby relating the position of document 60 with respect to scanner head 50. Once the border 72 of document 60 is determined, controller 18 uses the coordinates associated with border 72 to define and de-skew the RGB image data that corresponds to document 60.

Thereafter, print engine 20 may be used to print the de-skewed RGB image data associated with document 60.

As a further refinement of the present invention, the contrast of dark image 78 with respect to background 80 may be improved by including one or more dedicated light sources that are used to charge the phosphorescent material at phosphorescent area 70 of document pad 62. In all embodiments of the present invention, the light used for charging the phosphorescent material at phosphorescent area 70 of document pad 62 may be, for example, light in the visible light spectrum, including fixed frequency light, such as blue, or may be outside the visible light spectrum, such as ultraviolet light.

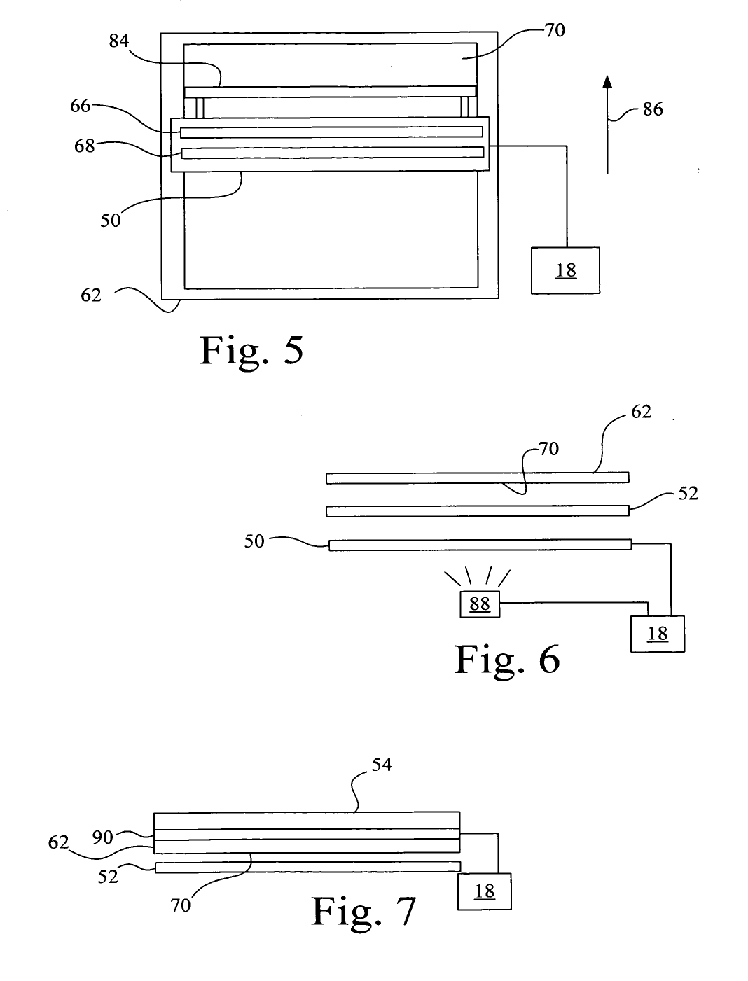

In one embodiment, for example, illustrated in FIG. 5, a dedicated illuminant 84, such as a light pipe, may be added to scanner head 50 and positioned upstream of illuminant 66 in scan direction 86. In this example, controller 18 may gate illuminant 84 ON at the beginning, or end, of each scan to charge the phosphorescent material at phosphorescent area 70 of document pad 62.

In another embodiment, referring again to FIGS. 1 and 2, illuminant 66 may be controlled by controller 18 to increase the intensity of illuminant 66 so that more light is leaked to the phosphorescent material at phosphorescent area 70 of document pad 62. Reflective surfaces, such as white plastic, may be used in the housing for illuminant 66 to increase the amount of light delivered to the phosphorescent material at phosphorescent area 70 of document pad 62.

In another embodiment, as illustrated in FIG. 6, a fixed position illuminant 88 may be located inside scanner unit 24, such as for example, below document glass 52. Fixed position illuminant 88 is coupled to controller 18, and turned ON once before every scan, or may be left on during the entire scan, so as to increase the amount of light delivered to the phosphorescent material at phosphorescent area 70 of document pad 62. When illuminant 88 is to be left ON during the entire scan, the frequency of light supplied by illuminant 88 may be selected so that the light does not interfere with the frequency of light supplied by scanner head 50 in collecting RGB image data.

In still another embodiment, as illustrated in FIG. 7, the phosphorescent material in phosphorescent area 70 of document pad 62 is charged from behind, such as for example, by positioning a backlighting illuminant 90 between scanner lid 54 and the phosphorescent material at phosphorescent area 70 of document pad 62. The operation of backlighting illuminant 90 is controlled by controller 18.

While this invention has been described with respect to embodiments of the invention, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An imaging apparatus configured for scanning a document, comprising:
a sensor for collecting image data; and
a phosphorescent material forming a phosphorescent area located opposite said sensor, wherein said document is positioned between said sensor and said phosphorescent area during a scanning operation.

2. The imaging apparatus of claim 1, further comprising:
a scanner lid; and
a document pad affixed to said scanner lid, wherein said phosphorescent material forms a surface of said document pad.

3. The imaging apparatus of claim 2, further comprising a document glass having a first side for supporting said document that faces said scanner lid, and a second side, said sensor being positioned to face said second side of said document glass.

4. The imaging apparatus of claim 1, wherein said phosphorescent area is greater than a surface area of said document.

5. The imaging apparatus of claim 1, further comprising an illuminant for charging said phosphorescent material.

6. The imaging apparatus of claim 1, wherein said phosphorescent material is charged by ambient light.

7. The imaging apparatus of claim 1, further comprising a controller communicatively coupled to said sensor, said sensor providing signals to said controller relating to light emitted by said phosphorescent material at various locations on said phosphorescent area, wherein said document is sensed by said sensor as a dark image in comparison to a background formed by said phosphorescent area.

8. The imaging apparatus of claim 7, wherein dark image data associated with said dark image is interleaved with RGB image data.

9. The imaging apparatus of claim 7, further comprising said controller executing program instructions to collect data relating to a boundary of said dark image for determining a border of said document.

10. The imaging apparatus of claim 9, further comprising said controller using coordinates associated with said border of said document to de-skew image data that corresponds to said document.

11. The imaging apparatus of claim 9, further comprising an illuminant used in collecting image data relating to said document and for charging said phosphorescent material, said controller executing program instructions to turn OFF said illuminant while said light emitted by said phosphorescent material is being sensed by said sensor.

12. The imaging apparatus of claim 9, further comprising a source of ambient light to charge said phosphorescent material, wherein said ambient light is substantially blocked while said light emitted by said phosphorescent material is being sensed by said sensor.

13. The imaging apparatus of claim 9, further comprising a dedicated illuminant used for charging said phosphorescent material, said controller executing program instructions to turn said dedicated illuminant ON and OFF at prescribed times in relation to a scanning of said document.

14. The imaging apparatus of claim 1, further comprising a print engine for printing image data associated with said document.

15. The imaging apparatus of claim 1, further comprising:
an illuminant; and
a controller coupled to said sensor and said illuminant, said controller executing program instructions to collect RGB image data associated with said document, and to collect dark image data associated with said document when said illuminant is OFF, said controller using only said dark image data to determine a border of said document.

16. The imaging apparatus of claim 15, further comprising said controller using coordinates associated with said border of said document to de-skew image data that corresponds to said document.

17. The imaging apparatus of claim 1, wherein said phosphorescent material is applied non-uniformly in said phosphorescent area.

18. The imaging apparatus of claim 17, wherein said phosphorescent material is sprinkled in said phosphorescent area.

19. The imaging apparatus of claim 1, wherein said phosphorescent material is applied uniformly in said phosphorescent area.

20. The imaging apparatus of claim 1, wherein said phosphorescent material is applied in a pattern in said phosphorescent area.

21. The imaging apparatus of claim 20, wherein said pattern is a grid pattern.

22. An imaging apparatus, comprising:
a controller; and
a scanner unit coupled to said controller for scanning a document, said scanner unit including:
an illuminant;
a document glass having a first side for supporting said document to be scanned and a second side opposite said first side;
a sensor positioned to face said second side of said document glass; and
a phosphorescent material forming a phosphorescent area positioned to face said first side of said document glass.

23. The imaging apparatus of claim 22, further comprising said sensor providing signals to said controller relating to light emitted by said phosphorescent material at various locations on said phosphorescent area, wherein said document is sensed by said sensor as a dark image in comparison to a background formed by said phosphorescent area.

24. The imaging apparatus of claim 23, wherein dark image data representing said dark image is generated to be interleaved with RGB image data representing said document.

25. The imaging apparatus of claim 23, further comprising said controller executing program instructions to collect data relating to a boundary of said dark image for determining a border of said document.

26. The imaging apparatus of claim 25, further comprising said controller using coordinates associated with said border of said document to de-skew image data that corresponds to said document.

27. The imaging apparatus of claim 22, further comprising said controller executing program instructions to turn OFF said illuminant while said light emitted by said phosphorescent material is being sensed by said sensor.

28. The imaging apparatus of claim 27, wherein said phosphorescent material is charged when said illuminant is ON.

29. The imaging apparatus of claim 28, wherein said illuminant is positioned to face said second side of said document glass.

30. The imaging apparatus of claim 22, wherein said illuminant is a dedicated illuminant used only for charging said phosphorescent material.

31. The imaging apparatus of claim 22, wherein said phosphorescent material is charged by ambient light, and wherein said ambient light is substantially blocked while said light emitted by said phosphorescent material is being sensed by said sensor.

32. The imaging apparatus of claim 22, further comprising:
a scanner lid; and
a document pad affixed to said scanner lid, wherein said phosphorescent material forms a surface of said document pad.

33. The imaging apparatus of claim 32, wherein said illuminant is positioned to supply light between said scanner lid and said phosphorescent material for charging said phosphorescent material.

34. The imaging apparatus of claim 22, further comprising a print engine coupled to said controller.

35. The imaging apparatus of claim 22, said controller executing program instructions to control said illuminant and said sensor to collect RGB image data associated with said document, and to collect dark image data associated with said document, said controller using only said dark image data to determine a border of said document.

36. The imaging apparatus of claim 35, further comprising said controller using coordinates associated with said border of said document to de-skew image data that corresponds to said document.
